(19) United States
(12) Patent Application Publication
(10) Pub. No.: US 2025/0233175 A1
(43) Pub. Date: Jul. 17, 2025

(54) METHOD FOR MONITORING AN ELECTROCHEMICAL SYSTEM, AND AN ELECTROCHEMICAL SYSTEM

(71) Applicant: Robert Bosch GmbH, Stuttgart (DE)

(72) Inventors: Hartwig Lehle, Stuttgart (DE); Markus Klinsmann, Stuttgart (DE); Nina Schelter, Boeblingen (DE); Zeeshan Shareef, Leonberg (DE)

(21) Appl. No.: 18/854,629

(22) PCT Filed: Apr. 5, 2023
(86) PCT No.: PCT/EP2023/059040

§ 371 Date: Oct. 7, 2024

(30) Foreign Application Priority Data
Apr. 7, 2022 (DE) 10 2022 203 504.6

(51) Int. Cl. H01M 8/04298; H01M 8/04664

(52) U.S. Cl. CPC H01M 8/04305; H01M 8/04671

(57) ABSTRACT

The invention relates to a method for monitoring an electrochemical system, in particular a high-temperature electrochemical system, preferably a fuel cell system, wherein, in at least one method step, a functionality of the electrochemical system is determined on the basis of at least one machine learning process (14, 16).

According to the invention, the functionality is determined using a degradation model which is at least partly separated from a reference model of the electrochemical system.

### BACKGROUND

Previously proposed is a method for monitoring a fuel cell system, in particular a high-temperature fuel cell system, whereby a functionality of the fuel cell system is determined in at least one method step on the basis of at least one machine learning process.

### SUMMARY

The invention proceeds from a method for monitoring an electrochemical system, in particular a high-temperature electrochemical system, preferably a fuel cell system, whereby a functionality of the electrochemical system is determined during at least one method step on the basis of at least one machine learning process.

In particular, an electrochemical system is provided for converting chemical energy into electrical energy, or vice versa. An electrochemical system can, e.g., be a fuel cell system that in particular enables the conversion of a fuel (e.g., hydrogen) into electrical energy, or an electrolysis cell system that in particular enables the conversion of electrical energy into chemical energy, preferably for storage. Accordingly, a high-temperature electrochemical system can, e.g., be a high-temperature fuel cell system or a high-temperature electrolysis cell system.

The invention of a fuel cell system is described hereinafter, without being limited to thereto. The invention can, e.g., thus also be provided for an electrolysis cell system, rather than a fuel cell system.

It is proposed that the functionality is determined using a degradation model which is at least partly separated from a reference model of the fuel cell system. The method is preferably provided in order to determine a degradation of the fuel cell system, in particular to predict it in advance. Degradation preferably refers to a, in particular gradual, decrease in the functionality of the fuel cell system, for example due to wear, aging processes, deposits, or the like. The functionality is preferably evaluated on the basis of at least one target parameter determined using the reference model and/or the degradation model. The at least one target parameter can be an operating parameter of the fuel cell system, e.g. an electrical voltage supplied by the fuel cell system, or an abstract indicator for the fuel cell system, which in particular comprises a plurality of operating parameters of the fuel cell system. The at least one target parameter is preferably output to an operator of the fuel cell system and/or to a higher-level control system. The at least one target parameter can optionally be further processed into an actual state of degradation, a degradation rate, an expected remaining service life of the fuel cell system, a timepoint when the next maintenance should be performed, or the like, before being output. Additionally or alternatively, the at least one target parameter is used by a control or regulation unit of the fuel cell system to control or regulate of the fuel cell system in order to, e.g., initiate a safety operation mode of the fuel cell system that limits the scope of performance if functional losses of the fuel cell system exceed a specified threshold value.

The reference model preferably forms at least one reference input parameter based on a reference value for the at least one target parameter. The degradation model preferably forms at least one degradation input parameter based on a degradation value for the at least one target parameter. The term “reference” or “degradation” in reference input parameters and degradation input parameters merely represents a naming convention for assigning the respective input parameter to the corresponding model. In principle, all parameters available during operation of the fuel cell system can be used as reference input parameters and/or as degradation input parameters. In particular, a parameter available may only be used as reference input parameters, only as degradation input parameters, or as both reference input parameters and degradation input parameters. The at least one reference input parameter and/or the at least one degradation input parameter can be sensed using at least one sensor of the fuel cell system, or it can be determined using a computing unit of the fuel cell system, in particular as a function of a variable sensed using the at least one sensor. The at least one reference input parameter and/or the at least one degradation input parameter can in particular be physical variables or abstract indicators. Preferably, the computing unit evaluates the reference model and/or the degradation model in order to determine the target parameter.

The reference model and the degradation model preferably complement one another in describing the fuel cell system, in particular in determining the at least one target parameter. The degradation model preferably describes a change, preferably all substantial changes, of the at least one target parameter due to a degradation of the fuel cell system. Examples that are used as degradation input parameters or are included in the at least one degradation input parameter include a cumulative operating period of the fuel cell system, a cumulative current flow rate of the fuel cell system, a cumulative number of thermal cycles of the fuel cell system, or another variable that describes or characterizes an aging of the fuel cell system. For example, a combination of a cumulative ageing value and an actual value of an operating parameter of the fuel cell system, e.g. a product from an actual value of a current flow rate of the fuel cell system and a cumulative operating period of the fuel cell system, is used as a degradation input parameter and/or is included in the at least one degradation input parameter. For example, a characterization variable of the fuel cell system, which is sensed, for example, after production and prior to initial service of the fuel cell system, is used as degradation input parameters and/or is included in the at least one degradation input parameter.

The reference model preferably describes a dependency of the target parameter on an actual value of an operating parameter and/or an operating condition of the fuel cell system. Examples of operating parameters which are used as reference input parameters or which are included in the reference input parameter are, for example, an electrical current generated by the fuel cell system, a combustible gas utilization of the fuel cell system, a combustible gas utilization of a fuel cell stack of the fuel cell system, a flow rate of a combustible gas, a flow rate of an oxygen-containing fluid, a characterization variable of the fuel cell system which is, e.g., sensed after production and before initial service of the fuel cell system, or the like. Examples of operating conditions that are used as reference input parameters or that are included in the reference input parameter are, for example, an ambient temperature, an ambient air pressure, or the like.

The reference model is preferably at least substantially independent of a degradation of the fuel cell system. Preferably, the reference model should be regarded as substantially independent of degradation if a change in reference value due to this degradation under otherwise constant operating conditions is at least less than 75%, preferably less than 50%, more preferably less than 25%, most preferably less than 10%, of a change in the degradation value due to this degradation during the same period of time. The at least one reference input parameter, in particular all reference input parameters, is/are preferably independent of a degradation due to, e.g., being kept constant by means of regulation. Alternatively, a dependence of the at least one reference input parameter on a degradation within the reference model is at least partly compensated for, in particular by a dependence of a further reference input parameter on this degradation. A dependence of the at least one reference input parameter on a degradation of the fuel cell system, in particular due to compensation and/or for a reason inherent to the reference input parameter, is preferably so low that the reference model is considered to be substantially independent of this degradation. For example, the reference model can describe the fuel cell system in a fully functional state, whereby the reference value represents an ideal value and is increasingly corrected by the degradation value as degradation proceeds. Alternatively, the reference model describes an allowable minimum functional state of the fuel cell system, whereby the reference value forms a base value that is supplemented by the degradation value as degradation progresses. Alternatively, the reference model describes the fuel cell system in a state having average functionality, in particular with respect to an expected service life of the fuel cell system.

In at least one embodiment, the degradation model and the reference model are separated in the sense that a determination of the degradation value is performed independently of a determination of the reference value, and/or a determination of the reference value is performed independently of a determination of the degradation value. The reference model and/or the degradation model are preferably created using the at least one machine learning process of a learning unit. The learning unit can be the aforementioned computing unit or an external further computing unit, whereby the reference model and/or the degradation model are transferred to a memory of the computing unit after the creation of the reference model and/or the degradation model, in particular automatically or manually. Depending on the choice of the target parameter, the specific design of the fuel cell system, and/or the choice of the machine learning process, the learning unit creates the reference model and the degradation model independently of each other, in unilateral dependence, or in mutual dependence on each other. Preferably, the learning unit is provided in order to separate a dependence of the at least one target parameter from the at least one reference input parameter and the at least one degradation input parameter, in particular as much as possible. It is conceivable that the reference model and the degradation model overlap one another. For example, when using a neural network as a machine learning process, said models can comprise one or multiple common input layers.

The learning unit preferably creates the reference model and the degradation model by evaluating training data. The training data comprise a dependence of the target parameter on at least one, in particular a plurality of input parameters. The training data can be generated by simulating the fuel cell system and/or sensed in other fuel cell systems. The learning unit preferably analyzes the training data to identify the at least one input parameter as a reference input parameter or as a degradation input parameter. For example, the learning unit analyzes the training data with regard to a correlation between the at least one input parameter and the at least one target parameter. If the learning unit finds a correlation between the at least one input parameter and a long-term trend of the at least one target parameter, it preferably identifies this input parameter as a degradation input parameter. If the learning unit does not find a correlation between the at least one input parameter and a long-term trend of the at least one target parameter, it preferably identifies this input parameter as a reference input parameter. Alternatively, the input parameters are divided into degradation input parameters and reference input parameters by a programmer of the learning unit. Preferably, the degradation model is trained on the training data, based on which the at least one reference input parameter has preferably been removed or is not included (hereinafter referred to as degradation training data). Preferably, the reference model is trained on the training data, based on which the at least one degradation parameter has preferably been removed or in which the at least one degradation parameter is not included (hereinafter abbreviated as reference training data).

The embodiment according to the invention enables a degradation and/or a degradation rate of the fuel cell system to be reliably determined in an advantageous manner. The risk of a trend in the target parameter, which not due to a degradation and which is in particular described by the reference model, being incorrectly detected can be minimized in an advantageous manner. In particular, an advantageously high level of plausibility can be achieved when determining the degradation and/or the degradation rate by interpreting the target parameter. Furthermore, the degradation model can be used directly, so that a modeled progression of the target parameter without short-term fluctuations can be obtained directly. Furthermore, a machine learning process that is advantageously easy to interpret can be used for the degradation model (e.g., linear regression), in particular while an advantageously complex and/or flexible machine learning process can simultaneously be used for the reference model.

It is further proposed that the degradation model is created using the machine learning process, and the reference model is created using a further machine learning process. The machine learning process and the further machine learning process can be the same type or different types of machine learning processes. The machine learning process and the further machine learning process can be performed by the same learning unit or by different learning units. For example, the degradation model is determined using linear regression or using a regularized variant of linear regression by means of, e.g., LASSO regression or ridge regression. It is also conceivable that a higher dimensional model, in particular a square or cubic model, be used for the degradation model. For example, the reference model is determined using a Gaussian process, a support vector machine, a decision tree, an ensemble variant of the methods previously specified, in particular using random Forest methods or using gradient boost methods, a neural network, or the like. The embodiment according to the invention enables the machine learning processes to be advantageously adapted specifically to the determination of the reference value and to the determination of the degradation value of the target parameter.

Furthermore, it is proposed that the degradation model and the reference model have independent dependencies from one another. The degradation model is preferably, in particular only, dependent on the at least one degradation parameter and is in particular independent of the at least one reference parameter. The reference model is preferably, in particular only, dependent on the at least one reference parameter and in particular independent of the at least one degradation parameter. Preferably, the degradation model and the reference model are determined using a machine learning process inherently separable with respect to the input parameters. For example, the degradation model and the reference model are determined jointly based on the training data using linear regression or using a regularized variant of linear regression, e.g. LASSO regression or ridge regression. The degradation model preferably comprises one coefficient, in particular one coefficient each, which is associated with the at least one degradation input parameter. To determine or predict the degradation value, the computing unit evaluates the, e.g., at least one coefficient of the degradation model, particularly while disregarding coefficients of the reference model. Alternatively, the degradation model and the reference model are evaluated by the computing unit together to determine the degradation value, whereby the at least one reference input parameter is set to a constant value. As a result of the embodiment according to the invention, the degradation model and/or the reference model can easily be created and evaluated in an advantageous manner.

It is further proposed that the degradation model and the reference model be determined by alternating iteration steps. The method preferably comprises a reference iteration step. In the reference iteration step, the learning unit preferably creates a reference part model using the further machine learning process and the reference training data, during which step the target parameter is replaced by a current transfer value. In a first run of the reference iteration step, the transfer value is set equal to the value of the target parameter included in the training data. In the reference iteration step, the learning unit preferably determines an iteration value of the target parameter using the reference part model determined in this reference iteration step. In the reference iteration step, the computing unit preferably determines a new transfer value as a function of a deviation from the iteration value for the target parameter determined in the reference iteration step from the previous transfer value. The method preferably comprises a degradation iteration step. The new transfer value is transferred as the current transfer value to the degradation iteration step. In the degradation iteration step, the learning unit preferably creates a degradation submodel using the machine learning process and the degradation training data, during which step the target parameter is replaced by the current transfer value. In the degradation iteration step, the learning unit preferably determines an iteration value of the target parameter using the degradation submodel determined in this degradation iteration step. In the degradation iteration step, the computing unit preferably determines a new transfer value as a function of a deviation of the iteration value of the target parameter determined in the degradation iteration step from the previous transfer value. The new transfer value is preferably transferred to the reference iteration step as the current transfer value. The reference iteration step and the degradation iteration step are preferably repeated until a measure of deviation, for example a mean square deviation, of the iteration value from the current transfer parameter is less than a specified threshold value. To determine or predict the degradation value using the degradation model (or determine or predict the reference value using the reference model), the computing unit preferably evaluates all degradation submodels and/or reference submodels created in the corresponding iteration steps and adds up their results. As a result of the embodiment according to the invention, any desired machine learning processes can be advantageously used to create the reference model and the degradation model.

It is further proposed that the degradation model is determined on the basis of the reference model. Preferably, in a model determination step of the method, the reference model is determined by the learning unit using the training dataset. In particular, the reference model is dependent on the at least one reference input parameter and the at least one degradation parameter. Preferably, in a further model determination step of the method, the degradation model is determined by the learning unit. In the further model determination step, the learning unit preferably uses the degradation training data, whereby the target parameter is replaced by a pseudo value of the target parameter in order to determine the degradation model. The learning unit preferably determines the pseudo value using the reference model determined in the model determination step, whereby the at least one degradation input parameter is used from the training data, and a replacement value is used for the at least one reference input parameter. The replacement value is, e.g., a constant value stored in a memory of the learning unit or an average of the values for the at least one reference input parameter included in the training data. The computing unit preferably determines an actual value of the degradation using the degradation model. A prediction of the target parameter determines the computing unit only using, e.g., the reference model. As a result of the embodiment according to the invention, the reference model and the degradation model can be created advantageously quickly and evaluated advantageously quickly.

It is further proposed that the degradation model and the reference model comprise a common, in particular non-zero, base value for determining at least one operating parameter of the fuel cell system. The degradation model and the reference model are, e.g., determined as discussed in the previous paragraph. The learning unit preferably determines the base value, in particular additionally. Preferably, the computing unit determines the base value in the form of target parameters taken from the training data, minus the degradation value determined from the training data using the degradation model, and minus the reference value determined based on the training data using the reference model. In determining the reference value, the learning unit preferably uses a constant value, in particular zero, in the reference model instead of the degradation input parameter for the training data. Preferably, the learning unit determines the base value for a plurality of, in particular all, datasets of the training data and forms an average from the obtained base values, which is stored as the base value in a memory of the computing unit. Preferably, the computing unit adds the saved base value, a prediction of the degradation value created using the degradation model, and a prediction for the reference value created using the reference model to a prediction for the target parameter, whereby the at least one degradation input parameter is kept constant in the reference model. As a result of this embodiment according to the invention, the reference model and the degradation model can be created advantageously quickly and evaluated advantageously quickly, whereby the degradation model can be additionally validated.

It is further proposed that the degradation model be extracted from a higher-level model to determine the reference model. Preferably, the reference model is determined as the remainder of the higher-level model after the degradation model has been extracted from the higher-level model. Preferably, in a model determination step of the method, the higher-level model is determined by the learning unit using the training dataset. In particular, the higher-level model depends on the at least one reference input parameter and the at least one degradation input parameter. In the further model determination step, the learning unit preferably uses the degradation training data, whereby the target parameter is replaced by the pseudo value of the target parameter in order to determine the degradation model. The learning unit preferably determines the pseudo value using the higher-level model determined in the model determination step, whereby the at least one degradation input parameter is used from the training data, and the replacement value is used for the at least one reference input parameter. The reference model is preferably determined using the reference training data, whereby the target parameter is determined by a difference between the target parameter included in the reference training data and the degradation value determined by the learning unit using the degradation model and the degradation training data. As a result of the embodiment according to the invention, the reference model and the degradation model can be created advantageously quickly and evaluated advantageously quickly, whereby the degradation model can be additionally validated.

Furthermore, an electrochemical system, in particular a high-temperature electrochemical system, preferably a fuel cell system comprising at least one computing unit, is proposed for performing a method according to the invention.

Here too, the invention is described in the following by way of example of a fuel cell system without being limited to it. For example, the invention can also relate to an electrolysis cell system instead of a fuel cell system.

The term “computing unit” or “learning unit” is understood in particular to mean a unit having an information input, information processing, and an information output. Advantageously, the computing unit or the learning unit comprises at least one processor, a storage, input, and output means, further electrical components, an operating program, regulating routines, control routines, and/or calculation routines. The components of the computing unit or the learning unit are preferably arranged on a common board and/or advantageously arranged within a common housing. Preferably, the computing unit or learning unit is specifically configured and/or specifically programmed to perform the method according to the invention. The fuel cell system preferably comprises at least one fuel cell device. The fuel cell device preferably comprises at least one fuel cell, in particular at least one fuel cell stack. The at least one fuel cell is preferably designed as a high-temperature fuel cell, e.g. as a solid oxide fuel cell (SOFC) or a molten carbonate fuel cell (MCFC). The at least one fuel cell is preferably provided to convert a combustible gas, in particular hydrogen and/or at least one hydrocarbon, under the supply of oxygen to generate an electrical power. The fuel cell device preferably comprises components for handling and/or preparing the combustible gas and/or an oxygen-containing fluid, in particular ambient air. Examples of these components include at least one ventilator, at least one reformer, at least one afterburner, at least one heat exchanger, at least one exhaust gas recirculation system, and/or other components that appear advantageous to a person skilled in the art. The fuel cell system preferably comprises at least one sensor, which is arranged in the fuel cell device in order to sense at least one operating parameter of the fuel cell system, in particular the fuel cell device. The fuel cell system preferably comprises at least one output unit, e.g. a display, indicator lights, a speaker or the like, in order to output the target parameter and/or a variable derived from the target parameter. The output unit, the computing unit, and/or the learning unit can be arranged on the fuel cell device, in particular within a housing or on a housing of the fuel cell device, or it can be designed to be separate from the fuel cell device and can communicate with, e.g., the fuel cell device, in particular the sensor, and/or with each other via a data network, in particular via the internet or via a private data network. As a result of the embodiment according to the invention, a fuel cell system can be provided, the degradation of which can be reliably monitored in an advantageous manner.

The method according to the invention and/or the fuel cell system according to the invention is/are not intended to be limited to the application and embodiment described hereinabove. In particular, the method according to the invention and/or the fuel cell system according to the invention can comprise a number of individual elements, components, units, and method steps that deviates from a number specified herein for fulfilling a mode of operation described herein. Moreover, regarding the ranges of values indicated in this disclosure, values lying within the limits specified hereinabove are also intended to be considered as disclosed and usable as desired.

### BRIEF DESCRIPTION OF THE DRAWINGS

Further advantages follow from the description of the drawings hereinafter. The drawings illustrate one exemplary embodiment of the invention. The drawings, the description, and the disclosure contain numerous features in combination. A person skilled in the art will appropriately also consider the features individually and combine them into additional advantageous combinations.

Shown are:

FIG. 1 a schematic representation of a fuel cell system according to the invention

and

FIG. 2 a schematic flow chart of a method according to the invention.

### DETAILED DESCRIPTION

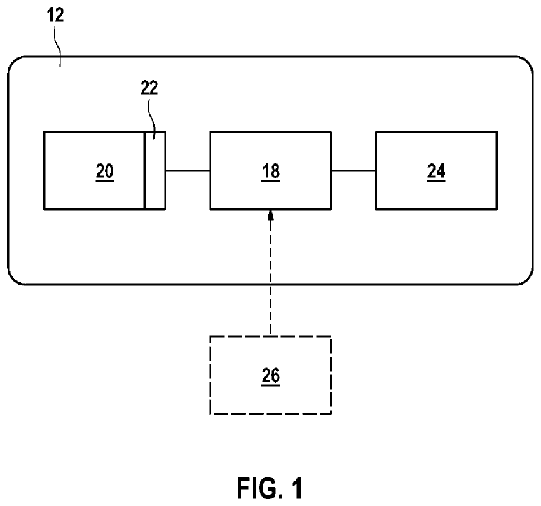

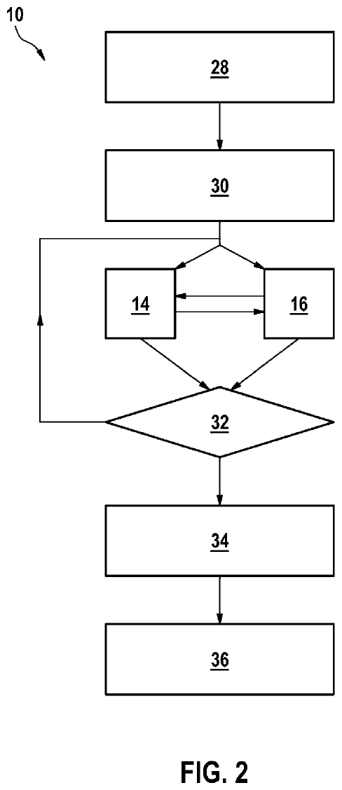

FIG. 1 shows a fuel cell system 12. The fuel cell system 12 preferably comprises a fuel cell device 20 for generating an electric current by electrochemical conversion of a combustible gas with oxygen. The fuel cell system 12 preferably comprises at least one sensor 22 for sensing at least one operating parameter of the fuel cell device 20. The fuel cell system 12 comprises a computing unit 18 for performing a method 10, which is shown in more detail in FIG. 2. The computing unit 18 is provided to determine a target parameter, in particular as a function of the at least one operating parameter sensed using the at least one sensor 22. A memory of the computing unit 18 preferably stores a degradation model and a reference model, by means of which the computing unit 18 determines the target parameter. The degradation model and/or the reference model can be created by the computing unit 18 or by an external learning unit 26. The term “learning unit” may hereinafter refer to the computing unit 18 or the external learning unit 26. The computing unit 18 is preferably provided for interpreting the target parameter with respect to a degradation of the fuel cell device 20. The fuel cell system 12 preferably comprises an output unit 24 for output of the target parameter and/or an interpretation of the target parameter regarding a degradation of the fuel cell device 20.

FIG. 2 shows the method 10 for monitoring the fuel cell system 12, in particular the fuel cell device 20. The method 10 preferably comprises a machine learning process 14. The method 10 preferably comprises a further machine learning process 16. The method 10 preferably comprises an evaluation step 34. In the evaluation step 34 of the method 10, a functionality of fuel cell system 12 is determined on the basis of at least one of the machine learning processes 14, 16 from the computing unit 18. The functionality is determined by the computing unit 18 using the degradation model at least partly separated from the reference model of the fuel cell system 12. The degradation model is created by the learning unit using the machine learning process 14, and the reference model is created using the further machine learning process 16. Preferably, the computing unit 18 determines a degradation value of a target parameter using the degradation model. Preferably, the computing unit 18 determines a reference value of the target parameter using the reference model.

The method 10 preferably comprises a data retrieval step 28. The data retrieval step 28 collects training data, by means of which the machine learning processes 14, 16 are created. The training data preferably comprises datasets of input parameters and values of the target parameter. The input parameters are preferably equal to the operating parameters that can be sensed by the sensor 22 or a variable or indicator derived therefrom. The input parameters can in particular be selected as any desired combination of operating parameters in the course of feature engineering. Particularly preferably, the target parameter is equal to an electrical voltage associated with the electric current generated by the fuel cell device 20. The training data can be generated by simulating the fuel cell device 20 or via sensing on other fuel cell devices.

The method 10 preferably comprises a preprocessing step 30 for preprocessing the training data. Preferably, the training data is filtered, in particular with regard to an operating period of the fuel cell device 20. For example, only datasets of the training data that have been sensed or created within a specified nominal load range of the fuel cell device 20 are used further. For example, only datasets of the training data in which the input parameters fluctuate by less than a specified tolerance value and which, in particular, describe a steady state of the fuel cell device 20 are used further. Optionally, a preselection is performed of the types of fuel cell devices 20 to be considered, which are to be described by the degradation model and the reference model.

Depending on the influence of the input parameters on the target parameter, the learning unit or a programmer of the learning unit preferably assigns the input parameters to the reference model as reference input parameters, in particular if the influence is relatively low, or to the degradation model as degradation input parameters, in particular if the influence is relatively high. Preferably, the computing unit 18 creates reference training data comprising the reference input parameters and the target parameter, and degradation training data comprising the degradation input parameters and the target parameters from the training data. The learning unit executes the machine learning process 14 to create the degradation model, preferably using the degradation training dataset. The learning unit performs the further machine learning process 16 to determine the reference model, preferably using the reference training dataset.

The method 10 optionally comprises a validation step 32. In the validation step 32, a value of the target parameter is predicted using the determined degradation model and/or the determined reference model and compared to test data. If the test data and the predicted value match sufficiently, the degradation model and the reference model are stored in a memory of the computing unit 18. If the test data and predicted value do not match sufficiently, the machine learning process 14 and the further machine learning process 16 are repeated, preferably on the basis of another machine learning model. Alternatively, multiple machine learning models known to the learning unit are executed in sequence and the validation step 32 determines which machine learning model was used to create the most precise degradation model and the most precise reference model. When executing the machine learning process 14 and further machine learning process 16 using linear regression or another machine learning model that is inherently separable with respect to the input parameters, the degradation model and the reference model have mutually independent dependencies on these input parameters. When executing the machine learning process 14 and further machine learning process 16, the degradation model and the reference model are determined by alternating iteration steps. When executing the machine learning process 14 and further machine learning process 16, the degradation model is determined based on the reference model. When executing the machine learning process 14 and the further machine learning process 16, the learning unit determines a base value common to the degradation model and the reference model, in particular non-zero, which the computing unit 18 uses to determine the target parameter. When executing the machine learning process 14 and further machine learning process 16, the learning unit triggers the degradation model from a higher-level model to determine the reference model.

In the evaluation step 34, the computing unit 18 evaluates the reference model and/or the degradation model on the basis of the operating parameters determined using the at least one sensor 22 in order to obtain an actual value of the target parameter or a prediction of the target parameter. Preferably, the computing unit 18 interprets the target parameter with regard to a degradation and/or a degradation rate of the fuel cell device 20. The method 10 preferably comprises an output step 36, in which the output unit 24 outputs the target parameter and/or its interpretation with regard to a degradation and/or a degradation rate.

In one alternative exemplary embodiment (not described in detail), an electrolysis cell system could be designed in a manner similar to the fuel cell system 12 shown in FIG. 1. Accordingly, the electrolysis cell system 12 could preferably comprise an electrolysis cell device for generating hydrogen by the electrochemical conversion of water by means of electrical energy. Accordingly, the electrolysis cell system could also comprise at least one sensor for sensing at least one operating parameter of the electrolysis cell device. The electrolysis cell system could further comprise a computing unit for performing a method similar to FIG. 2. Accordingly, the computing unit could be provided to determine a target parameter, in particular as a function of the at least one operating parameter sensed using the at least one sensor. A memory of the computing unit 18 could preferably store a degradation model and a reference model, by means of which the computing unit determines the target parameter. The degradation model and/or the reference model can be created by the computing unit or by an external learning unit. The term “learning unit” could hereinafter refer to the computing unit or the external learning unit. The computing unit could preferably be provided for interpreting the target parameter with regard to a degradation of the electrolysis cell device. The electrolysis cell system preferably could also comprise an output unit for output of the target parameter and/or an interpretation of the target parameter regarding a degradation of the fuel cell device.

Accordingly, according to the alternative exemplary embodiment, a method for monitoring the electrolysis cell system, in particular the electrolysis cell device, could be performed in a manner similar to FIG. 2. The method could preferably comprise a machine learning process. The method could also preferably comprise a further machine learning process 16. The method could preferably comprise an evaluation step. In the evaluation step of the method, a functionality of the electrolysis cell system could be determined on the basis of at least one of the machine learning processes from the computing unit. The functionality could be determined by the computing unit using the degradation model that is at least partly separated from the reference model of the electrolysis cell system. The degradation model could be created by the learning unit using the machine learning process 14, and the reference model could be created using the further machine learning process. Preferably, the computing unit determines a degradation value for a target parameter using the degradation model. Preferably, the computing unit determines a reference value for the target parameter using the reference model.

The method could also preferably comprise a data retrieval step for the alternative exemplary embodiment. The data retrieval step could collect training data, by means of which the machine learning processes are created. The training data could preferably comprise datasets of input parameters and values of the target parameter. The input parameters could be preferably equal to the operating parameters that can be sensed by the sensor or a variable or indicator derived therefrom. The input parameters can in particular be selected as any desired combination of operating parameters in the course of feature engineering. Particularly preferably, the target parameter would be equal to the amount of hydrogen generated by the electrolysis cell device. The training data can be generated by simulating the electrolysis cell device or via sensing on other electrolysis cell devices.

In the context of this alternative exemplary embodiment, the method could also preferably comprise a preprocessing step for preprocessing the training data. Preferably, the training data is filtered, in particular with respect to an operating period of the electrolysis cell device. For example, only datasets of the training data that have been sensed or created within a specified nominal load range of the electrolysis cell device are used further. For example, only datasets of the training data in which the input parameters fluctuate by less than a specified tolerance value and which, in particular, describe a steady state of the electrolysis cell device are used further. Optionally, a preselection is made of the types of electrolysis cell devices to be considered, which are intended to be described by the degradation model and the reference model.

In the alternative exemplary embodiment, depending on the influence of the input parameters on the target parameter, the learning unit or a programmer of the learning unit could preferably assign the input parameters to the reference model in the form of reference input parameters, in particular if the influence is relatively low, or to the degradation model in the form of degradation input parameters, in particular if the influence is relatively high. Preferably, the computing unit could create reference training data based on the training data and including the reference input parameters as well as the target parameter, and based on degradation training data comprising the degradation input parameters and the target parameter. The learning unit could execute the machine learning process to create the degradation model, preferably using the degradation training dataset. The learning unit could perform the further machine learning process to determine the reference model, preferably using the reference training dataset.

The method could also optionally comprise a validation step in the context of the alternative exemplary embodiment. In the validation step, a value of the target parameter could be predicted using the determined degradation model and/or the determined reference model and compared to test data. If the test data and the predicted value match sufficiently, the degradation model and the reference model could be stored in a memory of the computing unit 18. If the test data and predicted value do not match sufficiently, then the machine learning process and the further machine learning process could be repeated, preferably on the basis of another machine learning model. Alternatively, multiple machine learning models known to the learning unit could be executed in sequence, and the validation step can determine which learning model was based on the most precise degradation model and the most precise reference model. When executing the machine learning process and the further machine learning process using linear regression or another machine learning model that would be inherently separable with respect to the input parameters, the degradation model and the reference model could have mutually independent dependencies on these input parameters. When executing the machine learning process and the further machine learning process, the degradation model and the reference model could be determined by alternating iteration steps. When executing the machine learning process and further machine learning process, the degradation model could be determined on the basis of the reference model. When executing the machine learning process and the further machine learning process, the learning unit could determine a base value common to the degradation model and the reference model, in particular non-zero, which the computing unit could use to determine the target parameter. When executing the machine learning process and further machine learning process, the learning unit could trigger the degradation model from a higher-level model to determine the reference model.

In the context of this alternative exemplary embodiment, the computing unit could accordingly also evaluate the reference model and/or the degradation model in the evaluation step 34 on the basis of the operating parameters determined using the at least one sensor 22 in order to obtain an actual value of the target parameter or a prediction of the target parameter. The computing unit could preferably interpret the target parameter with regard to a degradation and/or degradation rate of the electrolysis cell device. The method could also preferably comprise an output step, in which the output unit outputs the target parameter and/or the interpretation thereof with regard to a degradation and/or a degradation rate.

1. A method for monitoring an electrochemical system, the method comprising: determining a functionality of the electrochemical system using at least one machine learning process (14, 16) performed in an electronic computer, wherein the functionality is determined using a degradation model which is at least partly separated from a reference model of the electrochemical system.

2. The method according to claim 1, wherein the degradation model is created using the machine learning process (14), and the reference model is created using a further machine learning process (16).

3. The method according to claim 1, wherein the degradation model and the reference model feature dependencies that are independent from one another.

4. The method according to claim 1, wherein the degradation model and the reference model are determined by alternating iteration steps.

5. The method according to claim 1, wherein the degradation model is determined based on the reference model.

6. The method according to claim 1, wherein the degradation model and the reference model comprise a common, non-zero, base value for determining at least one operating parameter of the electrochemical system.

7. The method according to claim 1, wherein the degradation model is extracted from a higher-level model to determine the reference model.

8. (canceled)
